(19) United States
(12) Patent Application Publication
(10) Pub. No.: US 2019/0158387 A1
(43) Pub. Date: May 23, 2019

(54) METHOD FOR MATCHING FLOW TABLES IN A SOFTWARE DEFINED NETWORKING

(71) Applicants: Inventec (Pudong) Technology Corp., Shanghai (CN); Inventec Corporation, Taipei (TW)

(72) Inventors: Hung-Wei Chen, Taipei (TW); Jheng-Jyun Wang, Taipei (TW); Chi-Hsiang Hung, Taipei (TW); Li-Chun Wang, Taipei (TW)

(21) Appl. No.: 15/862,657

(22) Filed: Jan. 5, 2018

(30) Foreign Application Priority Data
Nov. 17, 2017 (CN) 201711142562.X

(51) Int. Cl. H04L 12/721; H04L 12/741; H04L 12/743; H04L 29/06

(52) U.S. Cl. CPC H04L 45/38; H04L 45/54; H04L 69/22; H04L 45/7453; H04L 45/566

(57) ABSTRACT

A method includes a switch of the software defined networking analyzing a header of a package to retrieve at least one related rule field when the switch receives the package, selecting a related flow table according to the at least one related rule field and a plurality of interested rule fields of a plurality of flow tables in the switch, and matching the rule content corresponding to at least one flow entry in the related flow table with the content of the at least one related rule field. The at least one flow entry has the same interested rule field and the at least one related rule field includes the interested rule field of the related flow table.

### BACKGROUND OF THE INVENTION

### 1. Field of the Invention

The present invention is related to a method for matching flow tables, and more particularly, a method for matching flow tables in a software defined networking with a higher comparing speed.

### 2. Description of the Prior Art

In traditional network structures, the transferring rules of each switch are controlled by an exclusive routing algorithm. Therefore, when the routing rule needs to be changed, it has to be done manually to set up the rules in the switches along the routing path. The software defined networking (SDN) provides a better solution. The SDN separates the control plane and the data plane in the switch, and move the control plane to a centralized system. That is, the SDN can use the same control management logic to control the settings of the flow tables of all switches, and the switches would update the rules passively according to the control plane and focus on flow transferring. The separated structures of control plane and data plane in SDN make the network topology more expansible, manageable, and programmable.

The controller and the switch are two basic units in SDN. The controller is in charge of basic network management, such as setting the rules in the flow table of the switch, and monitoring the status of the network. The switch will obey the rules set by the controller in the flow table to transfer packages, and respond to the instructions from the controller passively. The controller and the switch can communicate with each other with a specific protocol, such as the OpenFlow protocol, and the controller can control the flow distribution in the network by adding, deleting or editing the rules in the switches.

In the SDN application, due to the characteristics of high speed comparison in linear time, the ternary content addressable memory (TCAM) is often used to store the flow table in a switch. However, comparing to other ordinary content addressable memory, the ternary content addressable memory requires a greater area, greater power, and greater costs. Therefore, in practice, it is impossible to equip the ternary content addressable memory with a large capacity. Therefore, the capacity of the flow table would be limited, and the overflow issue may occur easily, resulting in lost packages and low transferring efficiency.

In addition, although the hardware based ternary content addressable memory has a high performance in terms of making comparison, it is not flexible: once the hardware is manufactured, the comparison fields and the comparison schemes would be difficult to change. Therefore, it is difficult to upgrade as the new version of OpenFlow protocol, and its programmability is poor. However, a software based switch does not have these limitations. The software based switch can change the comparison schemes and the data structure for storing the flow entries to support the latest version of OpenFlow, and can store a great amount of flow entries in the huge system memory.

However, the comparing speed of the software based switch is far lower than the comparing speed of the ternary content addressable memory, in some cases, it is 10⁶ times lower. Therefore, how to improve the performance of the software based switch has become an important issue.

### SUMMARY OF THE INVENTION

One embodiment of the present invention discloses a method for matching flow tables in a software defined networking (SDN). The method includes a switch in a software defined networking analyzing a header of a package to retrieve at least one related rule field corresponding to the package when the switch receives the package, selecting a related flow table from a plurality of flow tables according to the at least one related rule field corresponding to the package and a plurality of interested rule fields of the plurality of flow tables in the switch, and matching rule content corresponding to at least one flow entry in the related flow table with content of the at least one related rule field corresponding to the package.

The flow entries in the related flow table have at least one common interested rule field. The at least one related rule field includes the at least one common interested rule field of the flow entries in the related flow table.

Another embodiment of the present invention discloses a switch applied in a software defined networking (SDN). The switch includes a plurality of flow tables, and a control unit.

When the control unit receives a package, the control unit analyzes a header of the package to retrieve at least one related rule field corresponding to the package, selects a related flow table from the plurality of flow tables according to the at least one related rule field corresponding to the package and a plurality of interested rule fields of the plurality of flow tables, and matches rule content corresponding to at least one flow entry in the related flow table with content of the at least one related rule field corresponding to the package.

The flow entries in the related flow table have at least one common interested rule field. The at least one related rule field includes the at least one common interested rule field of the flow entries in the related flow table.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a switch according to one embodiment of the present invention.

FIG. 2 shows a flow chart of a method for matching flow tables according to one embodiment of the present invention.

FIG. 3 shows the steps of the method in FIG. 2 according to one embodiment.

### DETAILED DESCRIPTION

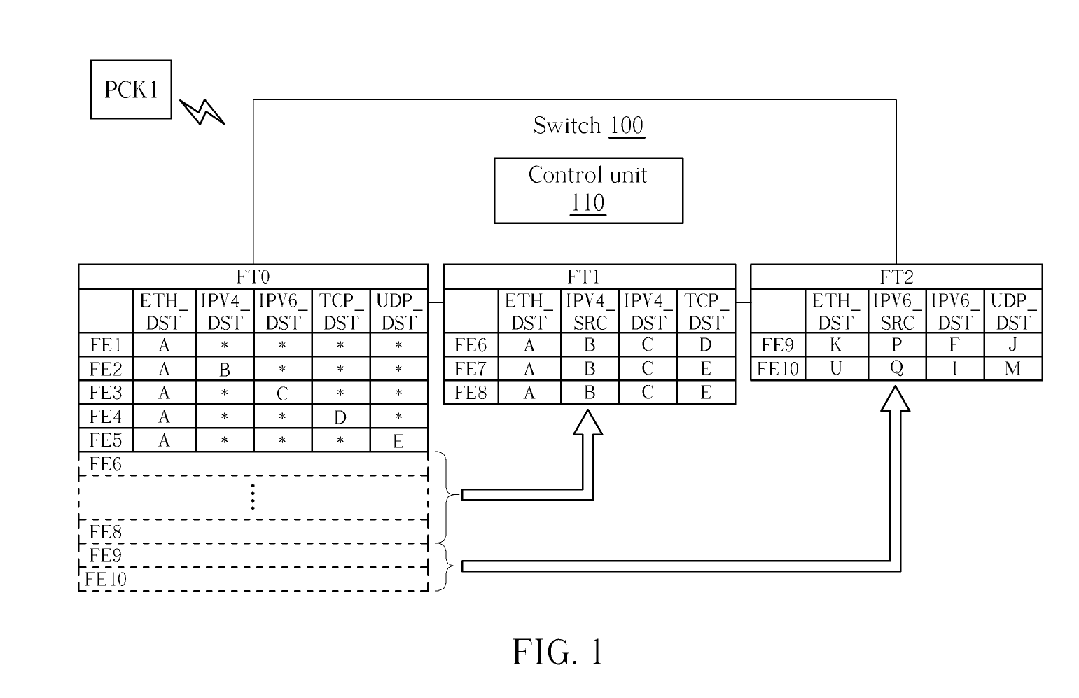

FIG. 1 shows a switch 100 according to one embodiment of the present invention. The switch 100 includes a plurality of flow tables FT0 to FT2, and a control unit 110. In some embodiments of the present invention, the switch 100 can be a software base switch applied in a software defined networking (SDN), that is, the switch 100 can change the comparison mechanism for internal flow tables and the data structure for storing the flow entries by software.

In some embodiments, to improve the package handling performance of the switch 100, the switch 100 can reduce the number of flow entries to be compared by classifying and dividing the flow table. Generally, since the information stored in the header and the flow entries have corresponding relations, the flow table in the switch 100 can be classified and divided accordingly so the switch 100 can select the related flow table to do the comparison according to the information stored in the header without comparing the flow entries in other unrelated flow tables.

For example, Table 1 shows all the rule fields to be compared in a flow table, including the source (IPV4_SRC) and the destination (IPV4_DST) of the Internet Protocol version 4 (IPv4), the source (TCP_SRC) and the destination (TCP_DST) of the Transmission Control Protocol (TCP), and so on.

TABLE 1

| | | | | | | | | | | | | |
|---|---|---|---|---|---|---|---|---|---|---|---|---|
| IN_{—} | ETH_{—} | ETH_{—} | ETH_{—} | IP_{—} | IPV4_{—} | IPV4_{—} | IPV6_{—} | IPV6_{—} | TCP_{—} | TCP_{—} | UDP_{—} | UDP_{—} |
| PORT | DST | SRC | TYPE | PROTO | SRC | DST | SRC | DST | SRC | DST | SRC | DST |

However, generally, some of the rule fields may be exclusive with one another. For example, the package using IPv4 will not use IPv6 at the same time, or the package using TCP will not use the user datagram protocol (UDP) at the same time. That is, for each flow entry, there are only some of the rule fields needed to be compared (hereafter in the specification called interested rule field). Also, in one flow table, the flow entries may have different interested rule fields to be compared. In some embodiments, the switch 100 can remove the flow entries having the common interested rule fields from the flow table and establish a new flow table including the removed flow entries having the common interested rule fields.

For example, in FIG. 1, the flow entries stored in the flow tables FT1 and FT2 can be originally stored in the flow table FT0, however, as the number of flow entries grows, the switch can remove the flow entries FE6 to FE8 having the common rule fields of ETH_DST, IPV4_SRC, IPV4_DST, and TCP_DST from the flow table FT0, and establish the flow table FT1 to store the flow entries FE6 to FE8. Similarly, the switch 100 can establish the flow table FT2 to store the flow entries FE9 and FE10 having the common rule fields of ETH_DST, IPV6_SRC, IPV6_DST, and UDP_DST.

Consequently, when the switch 100 receives a package PCK1, the control unit 110 can analyze the header of the package PCK1 to retrieve at least one related rule field corresponding to the package PCK1, and select a related flow table from the flow tables FT0 to FT2 according to the related rule field corresponding to the package PCK1 and the interested rule fields of the flow tables FT0 to FT2 for comparison.

TABLE 2

| IN_PORT | ETH_DST | ETH_SRC | ETH_TYPE | IP_PROTO | IPV4_SRC | IPV4_DST | TCP_SRC | TCP_DST |
|---|---|---|---|---|---|---|---|---|
| 1 | C9:61:78:32:5d:61 | C9:61:78:32:5a:61 | 0x0800 | 0x06 | 192.196.1.1 | 128.119.5.1 | 63654 | 80 |

The related rule fields corresponding to the package PCK1 are IN_PORT, ETH_DST, ETH_SRC, ETH_TYPE, IP_PROTO, IPV4_SRC, IPV4_DST, TCP_SRC and TCP_DST, and the related rule fields corresponding to the package PCK1 include all the interested rule fields of the flow table FT1 but not all the interested rule fields of the flow table FT2, meaning that the package PCK1 may be matched with the flow entries in the flow table FT1, but will not be matched with the flow entries in the flow table FT2. Therefore, in this case, the switch 100 would select the flow table FT1 as the related flow table. That is, the control unit 110 of the switch 100 will compare the content in the related rule fields corresponding to the package PCK1 with the rule content corresponding to the flow entries in the flow table FT1, but leave the content of the flow table FT2 not compared.

In other words, the switch 100 needs only to compare the content of the entries in the related flow tables, but does not need to compare the content of all flow tables. Therefore, the comparing performance of the switch 100 can be improved effectively.

Also, to select the related flow table quickly, in some embodiments, the selection can be performed with vector comparison. For example, the control unit 110 can derive a target field vector of the package PCK1 according to the related rule fields, and derive the interested field vectors of the flow tables FT0 to FT2 according to the interested rule fields of the flow tables FT0 to FT2. Table 3, Table 4, and Table 5 respectively show the target field vector of the package PCK1, the interested field vector of the flow table FT1, and the interested field vector of the flow table FT2.

TABLE 3

| IN_{—} | ETH_{—} | ETH_{—} | ETH_{—} | IP_{—} | IPV4_{—} | IPV4_{—} | IPV6_{—} | IPV6_{—} | TCP_{—} | TCP_{—} | UDP_{—} | UDP_{—} |
|---|---|---|---|---|---|---|---|---|---|---|---|---|
| PORT | DST | SRC | TYPE | PROTO | SRC | DST | SRC | DST | SRC | DST | SRC | DST |
| 1 | 1 | 1 | 1 | 1 | 1 | 1 | 0 | 0 | 1 | 1 | 0 | 0 |

TABLE 4

| IN_{—} | ETH_{—} | ETH_{—} | ETH_{—} | IP_{—} | IPV4_{—} | IPV4_{—} | IPV6_{—} | IPV6_{—} | TCP_{—} | TCP_{—} | UDP_{—} | UDP_{—} |
|---|---|---|---|---|---|---|---|---|---|---|---|---|
| PORT | DST | SRC | TYPE | PROTO | SRC | DST | SRC | DST | SRC | DST | SRC | DST |
| 1 | 1 | 1 | 1 | 1 | 1 | 1 | 0 | 0 | 1 | 1 | 0 | 0 |

TABLE 5

| IN_{—} | ETH_{—} | ETH_{—} | ETH_{—} | IP_{—} | IPV4_{—} | IPV4_{—} | IPV6_{—} | IPV6_{—} | TCP_{—} | TCP_{—} | UDP_{—} | UDP_{—} |
|---|---|---|---|---|---|---|---|---|---|---|---|---|
| PORT | DST | SRC | TYPE | PROTO | SRC | DST | SRC | DST | SRC | DST | SRC | DST |
| 0 | 1 | 0 | 0 | 0 | 0 | 0 | 1 | 1 | 0 | 0 | 0 | 1 |

In other words, the switch 100 can take the rule fields to be compared in the flow table as different bases of the vector, set the value to 1 if the rule field has corresponding content, and set the value to 0 if the rule field does not have any corresponding content. Consequently, the target field vector of the package PCK1 would be set to (1,1,1,1,1,1,1,0,0,1,1,0,0), the interested field vector of the flow table FT1 would be set to (0,1,0,0,0,1,1,0,0,0,1,0,0), and the interested field vector of the flow table FT2 would be set to (0,1,0,0,0,0,0,1,1,0,0,0,1). When comparing the target field vector and the interested field vectors, the switch 100 can obtain the matching result by simple logic computation. For example, if a basis in the interested field vector has a value 1 while the same basis in the target field vector also has a value 1, then the rule field corresponding to this basis would be considered as matched. For example, if all bases having a value 1 in the interested field vector of a flow table are corresponding to the rule fields whose corresponding bases in the target field vector also have a value 1, then it would be determined as matched. Contrarily, if any of the bases having a value 1 in the interested field vector of a flow table is corresponding to the rule field whose corresponding basis in the target field vector does not have a value 1, then it would be determined as mismatched. After determining that the interested field vector of flow table FT1 matches with the target field vector of the package PCK1, the flow table FT1 would be selected as the related flow table.

In addition, to further accelerate the comparing speed, after the switch 100 selects the related flow tables, the switch 100 can further use a hash function to compare the content of the package and the content of the flow entries in the related flow table. For example, the control unit 100 can calculate the reference index of each of the flow entries in the related flow table with a predetermined hash function according to the rule content corresponding to each of the flow entries in the related flow table. Also, after the package PCK1 is received, the control unit 110 can calculate the target index corresponding to the package PCK1 with the predetermined hash function according to the content in the related rule field corresponding to the package PCK1 (e.g., the content in the rule field corresponding to the interested rule fields of the related flow table FT2 shown in table 2). Consequently, the comparison can be done by comparing the reference index and the target index rapidly with complexity of O(1).

Furthermore, in some embodiments, the flow table FT0 can be a wildcard flow table. That is, the content of the interested rule fields of the flow entries in the flow table FT0 has to be compared with the related rule fields corresponding to the package PCK1 to claim a match, while the content of the rest of rule fields can be ignored. For example, in FIG. 1, the flow entry FE1 in flow table FT0 only cares about the content of the rule field ETH_DST, and does not care about the content in the rest of rule fields IPV4_DST, IPV6_DST, TCP_DST, and UDP_DST. Similarly, the flow entries FE2 to FE5 only care about the content of the rule field IPV4_DST, IPV6_DST, TCP_DST, and UDP_DST respectively. In this case, since each flow entry may have different interested rule fields, it is difficult to perform the comparison with hash functions. Therefore, in some embodiments, the control unit 110 can linearly compare the content of the related rule fields corresponding to the package PCK1 with the rule content corresponding to the flow entries in the wildcard flow table FT0.

In other words, the switch 100 can perform the comparison with mixed approaches. When comparing the flow entries for specific interested rule fields in flow tables such as flow tables FT1 and FT2, the hash function can be used for rapid comparison. When comparing the flow entries in a wildcard flow table, such as the flow table FT0, the comparison may be performed in a linear manner. Consequently, while comparing the flow entries in the related flow tables for reducing the number of times of comparison, the switch 100 can improve comparing efficiency.

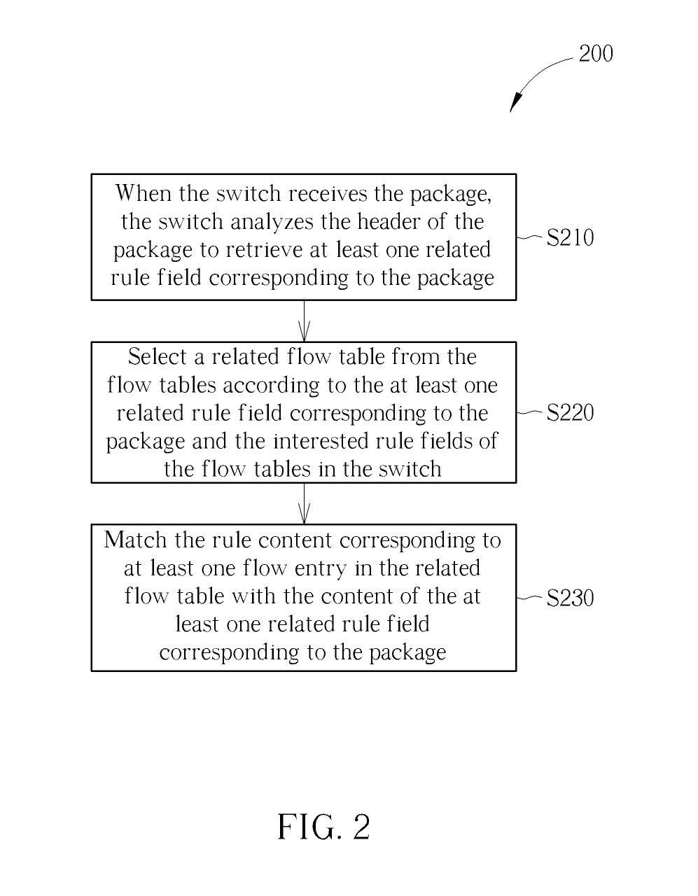

FIG. 2 shows a flow chart of a method 200 for matching flow tables according to one embodiment of the present invention. The method 200 can be applied to the switch 100 in the software defined networking. The method 200 includes steps S210 to S230.

S210: when the switch 100 in the software defined networking receives the package PCK1, the switch 100 analyzes the header of the package PCK1 to retrieve at least one related rule field corresponding to the package PCK1;

S220: select a related flow table from the flow tables FT0 to FT2 according to the at least one related rule field corresponding to the package PCK1 and the interested rule fields of the flow tables FT0 to FT2 in the switch 100,

S230: match the rule content corresponding to at least one flow entry in the related flow table FT1 with the content of the at least one related rule field corresponding to the package PCK1.

In step S210, the switch 100 can retrieve the related rule fields corresponding to the package PCK1, such as the content of the rule fields shown in table 2. In this case, the switch 100 would select the related flow table FT0 having its interested rule fields matched with the related rule fields corresponding to the package PCK1 in step S220, and can compare the rule content corresponding to the flow entries in the related flow table FT1 with the content of the related rule fields corresponding to the package PCK1 in step S230. In other words, with method 200, the switch 100 only needs to compare the related flow table having their interested rule fields matched with the related rule fields of the package, for example, the flow table FT1 with all its interested rule fields being included in the related rule fields corresponding to the package PCK1. Therefore, the number of flow entries to be compared can be reduced, and the comparing efficiency can be improved.

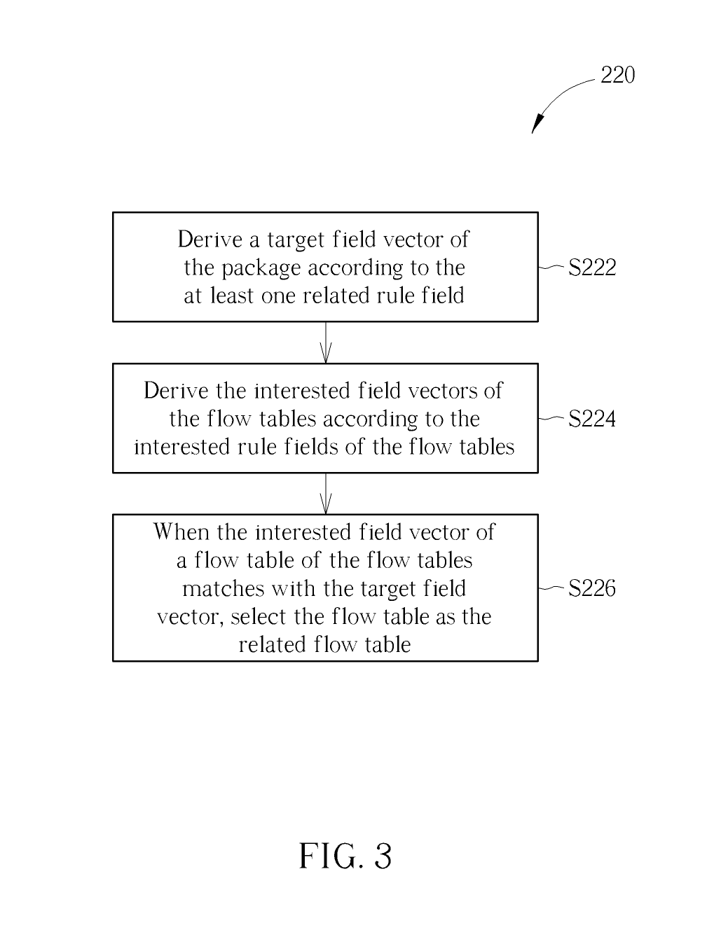

Also, in some embodiments, in step S220, to select the related flow table rapidly, the step S220 can include steps S222 to S226. FIG. 3 shows the steps S222 to S226 of the step S220 according to one embodiment.

S222: derive a target field vector of the package PCK1 according to the at least one related rule field;

S224: derive the interested field vectors of the flow tables FT0 to FT2 according to the interested rule fields of the flow tables FT0 to FT2; and

S226: when the interested field vector of a flow table of the flow tables FT0 to FT2 matches with the target field vector, select the flow table as the related flow table.

Take Tables 3 to 5 as examples, in steps S222 and s224, the switch 100 can derive the target field vector of the package PCK1 and the interested field vectors of the flow tables FT0 to FT2 respectively, and select the flow table FT1 having its interested field vector matching with the target field vector as the related flow table rapidly with logic computations.

In addition, to compare the flow entries in the related flow table rapidly, in some embodiments, the comparison can be performed with a predetermined hash function in step S230. That is, the switch 100 can calculate the reference index of each of the flow entries in the related flow table with a predetermined hash function according to the rule content corresponding to each of the flow entries in the related flow table in step S230. Also, in step S230, the control unit 110 can calculate the target index corresponding to the package PCK1 with the predetermined hash function according to the content in the related rule field corresponding to the package PCK1. Consequently, the comparison result can be obtained rapidly by comparing the calculated indices.

However, when comparing the flow entries in a wildcard flow tables, such as the flow table FT0, since the flow entries in the wildcard flow table may have different interested rule fields, the content of the related rule fields corresponding to the package PCK1 would be linearly compared with the rule content corresponding to the flow entries in the wildcard flow table FT0.

That is, the method 200 can perform the comparison with mixed approaches. When comparing the flow entries for specific interested rule fields in flow tables such as flow tables FT1 and FT2, the hash function can be used for rapid comparison. When comparing the flow entries in a wildcard flow table, such as the flow table FT0, the comparison may be performed in a linear manner. Consequently, while comparing the flow entries in the related flow tables for reducing the number of times of comparison, the switch 100 can improve comparing efficiency.

In addition, in some embodiments, to divide the flow tables according to its interested rule fields, the switch 100 can remove the flow entries having at least one common specific interested rule field from a default flow table, and establish a new flow table including the removed flow entries. For example, if the flow entries are originally stored in the flow table FT0 in the switch 100, then the switch 100 may remove the flow entries FE6 to FE8 having the same specific interested rule column from the flow table FT0 and establish the flow table FT1 including the removed flow entries FE6 to FE8. That is, the flow entries in the flow table FT1 would all have the same interested rule fields. Consequently, the method 200 would be able to divide the flow table according to the interested rule fields, reducing the flow entries to be compared.

In summary, the switch and the method for matching the flow tables can divide the flow table into several flow tables according to their interested rule field. Therefore, when the switch receives a package, the switch can select the related flow table from the several flow tables according to the related interested rule fields of the package. In this case, the switch can perform the comparison only with the flow entries in the related flow table, and can spare the comparison for the flow entries in other unrelated flow tables. Consequently, the number of entries to be compared can be reduced, and the comparing efficiency can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for matching flow tables in a software defined networking (SDN) comprising:
when a switch in the software defined networking receives a package, the switch analyzing a header of the package to retrieve at least one related rule field corresponding to the package;
according to the at least one related rule field corresponding to the package and a plurality of interested rule fields of a plurality of flow tables in the switch, selecting a related flow table from the plurality of flow tables; and
matching rule content corresponding to at least one flow entry in the related flow table with content of the at least one related rule field corresponding to the package;
wherein:
flow entries in the related flow table have at least one common interested rule field; and
the at least one related rule field comprises the at least one common interested rule field of the flow entries in the related flow table.

2. The method for matching the flow table of claim 1, further comprising:
removing a plurality of flow entries from a default flow table of the plurality of flow tables, wherein the plurality of removed flow entries are flow entries originally stored in the default flow table and having at least one common specific interested rule field; and
establishing a new flow table comprising the plurality of removed flow entries.

3. The method for matching the flow table of claim 1, wherein matching the rule content corresponding to the at least one flow entry in the related flow table with the content of the at least one related rule field corresponding to the package comprises:
calculating at least one reference index of the at least one flow entry with a hash function according to the rule content corresponding to the at least one flow entry; and
calculating a target index corresponding to the package with the hash function according to the content of the at least one related rule field corresponding to the package.

4. The method for matching the flow table of claim 1, wherein according to the at least one related rule field corresponding to the package and the plurality of interested rule fields of the plurality of flow tables in the switch, selecting the related flow table from the plurality of flow tables comprises:
deriving a target field vector of the package according to the at least one related rule field;
deriving a plurality of interested field vectors of the plurality of flow tables according to the plurality of interested rule fields of the plurality of flow tables; and
when an interested field vector of a flow table of the plurality of flow tables matches with the target field vector, selecting the flow table as the related flow table.

5. The method for matching the flow table of claim 1, wherein matching the rule content corresponding to the at least one flow entry in the related flow table with the content of the at least one related rule field corresponding to the package comprises:
linearly comparing the content of the at least one related rule field corresponding to the package with the rule content corresponding to at least one flow entry in a wildcard flow table.

6. A switch applied in a software defined networking (SDN) comprising:
a plurality of flow tables; and
a control unit configured to, when receiving a package:
analyze a header of the package to retrieve at least one related rule field corresponding to the package;
select a related flow table from the plurality of flow tables according to the at least one related rule field corresponding to the package and a plurality of interested rule fields of the plurality of flow tables; and
match rule content corresponding to at least one flow entry in the related flow table with content of the at least one related rule field corresponding to the package;
wherein:
flow entries in the related flow table have at least one common interested rule field; and
the at least one related rule field comprises the at least one common interested rule field of the flow entries in the related flow table.

7. The switch of claim 6, wherein the control unit is further configured to:
remove a plurality of flow entries from a default flow table of the plurality of flow tables, wherein the plurality of removed flow entries are flow entries originally stored in the default flow table and having at least one common specific interested rule field; and
establish a new flow table comprising the plurality of removed flow entries.

8. The switch of claim 6, wherein the control unit is configured to:
calculate at least one reference index of the at least one flow entry with a hash function according to the rule content corresponding to the at least one flow entry;
calculate a target index corresponding to the package with the hash function according to the content of the at least one related rule field corresponding to the package; and
use the at least one reference index and the target index to perform the matching.

9. The switch of claim 6, wherein the control unit is configured to:
derive a target field vector of the package according to the at least one related rule field;
derive a plurality of interested field vectors of the plurality of flow tables according to the plurality of interested rule fields of the plurality of flow tables; and
when an interested field vector of a flow table of the plurality of flow tables matches with the target field vector, select the flow table as the related flow table.

10. The switch of claim 6, wherein the control unit is further configured to linearly compare the content of the at least one related rule field corresponding to the package with the rule content corresponding to at least one flow entry in a wildcard flow table.
